(19) United States
(12) Patent Application Publication
(10) Pub. No.: US 2014/0096423 A1
(43) Pub. Date: Apr. 10, 2014

(54) VEHICLE INFORMATION HOLDER

(71) Applicant: COYNE COMMUNICATIONS, INC., Morristown, NJ (US)

(72) Inventor: Thomas Coyne, Morristown, NJ (US)

(73) Assignee: COYNE COMMUNICATIONS, INC., Morristown, NJ (US)

(21) Appl. No.: 14/046,141

(22) Filed: Oct. 4, 2013

Related U.S. Application Data
(60) Provisional application No. 61/744,866, filed on Oct. 4, 2012.

(51) Int. Cl. G09F 21/04; G09F 7/18

(52) U.S. Cl. CPC G09F 21/048; G09F 7/18
USPC 40/606.01

(57) ABSTRACT

A display device for displaying informational material, preferably through a motor vehicle window. The device includes a substantially planar body that integrally forms a folder with transparent viewing windows, and a clip portion which can hang from the top edge of an open motor vehicle window and fit into the window well when the window is closed.

### CROSS-REFERENCE TO RELATED APPLICATIONS

The present application claims the benefit of the filing date of U.S. Provisional Patent Application No. 61/744,866 filed Oct. 4, 2012, the disclosure of which is hereby incorporated herein by reference.

### BACKGROUND OF THE INVENTION

The present invention relates to a display device for informational materials, and more particularly, to a display device adapted to be hung from a motor vehicle window.

Legal requirements and common business practices dictate that certain informational material be displayed to potential customers for motor vehicle sales. This informational material lists vital statistics such as the motor vehicle's year, make, model, and gas mileage. Because this information is commonly printed on paper, the material is typically secured against the inside surface of a motor vehicle window using an adhesive such as tape to protect it from damage.

Use of an adhesive against a motor vehicle window presents several problems. The adhesive can weaken when exposed to hot weather and debris on the window (e.g., dust, lint, residue left from cleaning agents) may provide a poor base for the adhesive to adhere to. In addition, the adhesive itself can often leave a residue on surfaces after removal that is difficult to clean and may even damage window tinting.

Further, removing paper that has been secured to a surface using adhesive is time-consuming and frustrating and often leads to accidental destruction of the paper itself. This presents an even bigger problem in the context of motor vehicle sales because objects obstructing the motor vehicle windows need to be removed to allow prospective customers to test drive the motor vehicle.

Further still, existing display solutions also fail to meet three critical needs. First, many existing solutions do not provide an effective means of storing the information material inside the vehicle; thus exposing the materials to risk of damage by inclement weather or theft by unscrupulous parties. Second, many of these solutions do not provide a means of optimizing the display of the information materials to match the curvilinear shape of both the top edge and surface of modern motor vehicle windows, which can be critical to a potential consumer's perception of quality when reviewing the information in relation to the motor vehicle and motor vehicle sales person. And third, while some solutions permit removal of the information materials, they fail to firmly secure the materials within a protective case that is suitable for immediate re-display if the vehicle is not purchased.

Finally, prior vehicle information holders are generally optimized solely for the use of paper. Yet the use of paper for displaying information on a motor vehicle window creates additional inefficiencies due to the inherently static nature of the medium.

Therefore, there exists a need for a vehicle information holder that can address the aforementioned shortcomings of prior solutions and accommodate both paper-based and digital screen technologies.

### SUMMARY OF THE INVENTION

The present invention is directed to a display device for containing and displaying informational material. The device includes a housing portion having first and second panels which converge or connect at lower portions of both panels, thereby defining a folder between the panels for receiving the informational material and holding it securely in place. At least the front panel is substantially transparent to allow viewing of the informational material through the panels. The display device also includes a clip at an upper end of the housing portion for attachment to the top of a motor vehicle window and insertion into a motor vehicle's window well.

In accordance with one embodiment, the display is designed to contain and display informational material. This invention may include a substantially planar and transparent housing portion having a first panel and a second panel, each panel having an upper edge and a lower edge, where the upper edge of the second panel may extend past the upper edge of the first panel. In this embodiment, the panels are connected about the lower edges to create a folder capable of holding the materials. This clip portion is connected lengthwise along at least one length of the upper edge of the first or second panel, and sized so as to accept a portion of the top edge of an open motor vehicle window and to fit into a motor vehicle window well when the motor vehicle window is closed. In a preferred embodiment, the panels are connected about the lower edges so as to impart a clamping force between the first and second panel for holding the informational materials firmly in place if the display device is removed.

In an alternate embodiment, the housing portion of the display device is designed to rotate independently of a clip portion, which consists of a clip, an elongated body portion having an upper edge and a lower edge, and a rotatable connection. Here, the clip is connected lengthwise along at least one length of the upper edge of the elongated body portion and sized to accept a portion of the top edge of an open motor vehicle window and to fit into a motor vehicle window well when the motor vehicle window is closed. The rotatable connection may be located approximately at the centroid of the first or second panel; and the elongated body portion is rotatably connected to permit the clip to rotate past each corner of the panels.

In this alternate embodiment, the rotatable connection may be designed to impart friction between the clip portion and the second panel, thus permitting rotation of the housing portion to be fixed at any angle relative to the clip portion. Similar to above, the panels may also be connected about the lower edges so as to impart a clamping force between the first and second panels for holding the informational materials firmly in place if the display device is removed.

### BRIEF DESCRIPTION OF THE DRAWINGS

FIG. 1 is a front view of an embodiment of the display device in accordance with the present invention.

FIG. 2 is a side view of the display device shown in FIG. 1.

FIG. 3 is an enlarged perspective view of another embodiment of the display device in accordance with the present invention focusing on the clip.

FIG. 4 is a front view of another embodiment of the display device in accordance with the present invention.

FIG. 5a is an enlarged perspective view of an embodiment of the lower fold of the display device shown in FIG. 1 with information materials placed between the panels.

FIG. 5b is an enlarged side view of another embodiment of the lower fold to be utilized in the display device shown in FIG. 1.

FIG. 5c is an enlarged side view of another embodiment of the lower fold to be utilized in the display device shown in FIG. 1.

FIG. 5d is an enlarged side view of another embodiment of the lower fold to be utilized in the display device shown in FIG. 1.

FIG. 6 is a rear view of another embodiment of the display device in accordance with the present invention.

FIG. 7 is a rear view of the display device shown in FIG. 6 with the clip portion rotated independently past the corner of the housing portion.

FIG. 8 is a section view of the rotatable connection depicted in FIGS. 6 and 7.

FIG. 9 is a perspective view of the display device shown in FIG. 1 with the clip portion attached to the top of a motor vehicle window

FIG. 10 is a perspective view of the display shown in FIG. 1 with the clip portion engaged with a closed motor vehicle window.

FIG. 11 is a perspective view of another embodiment display device for displaying electronic media engaged with a closed the motor vehicle window.

### DETAILED DESCRIPTION

As used throughout this application, the term “Information Material(s)” broadly means any medium for communicating information, including, without limitation, information contained and display on printed paper comprised of pulp, paper, board, or other cellulose-based paper product, and information contained and displayed within rigid or flexible digital screen technologies or similar electronic devices.

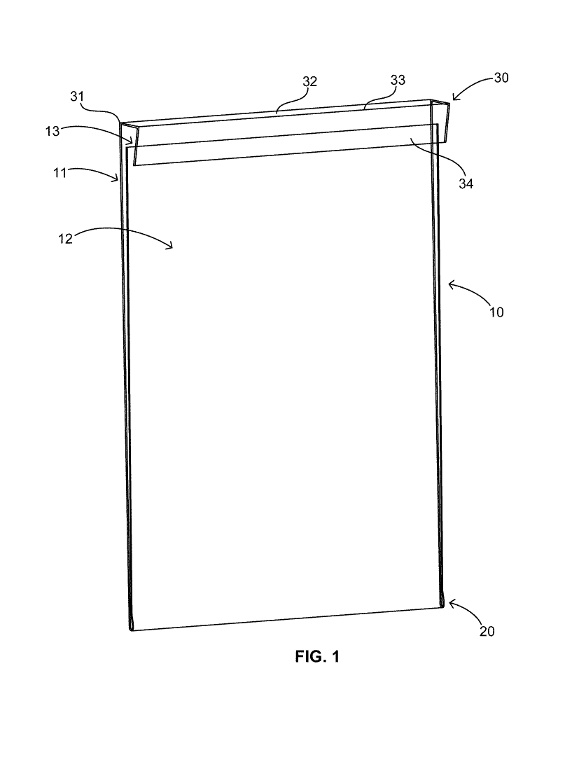

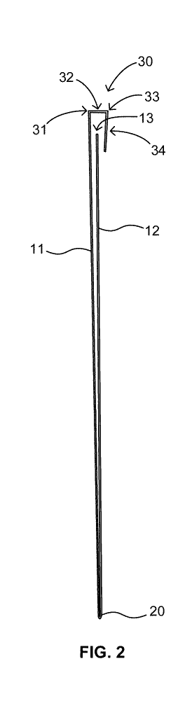

FIGS. 1 and 2 show a front and side view, respectively, of one embodiment of display device 10 according to the present invention. Display device 10 includes two panels and 12 connected at a fold 20, with panel 11 preferably extending vertically from fold 20 beyond an upper edge 13 of panel 12.

The embodiments depicted in FIGS. 1 and 2 are preferably constructed of a single sheet of clear polymeric material that allows panels 11 and 12 to move away from one another about fold 20. This construction makes display device 10 sufficiently pliable to allow panels 11 and 12 to become temporarily separated from each other; thus permitting the placement of information materials between those two components as discussed below. In addition, and in compliment to the other features discussed below, this construction also works to capture the information materials within display device 10. In a preferred embodiment, device 10 is constructed of polycarbonate, but other embodiments may employ different materials to achieve similar results. Preferably, such materials would have an elastic nature that acts to move the panels back together as discussed.

As shown particularly in FIG. 2, display device 10 includes a clip 30 having a rectangular profile comprised of a fold 31, which, as discussed further below, is designed to accept a portion of a motor vehicle window. In a preferred embodiment, clip 30 includes a top portion 32 of clip 30 that extends forward from panel 11 an interior distance equivalent to at least the sum of the width of a motor vehicle window plus the width of panel 12; and a fold 33, which extends a face portion 34 of clip 30 downward from top portion 32. In this embodiment, face portion 34 preferably extends past upper edge 13 of panel to secure the face of panel 12 firmly against the motor vehicle window when the window is open, although similar results may be achieved even if face portion 34 is nominal or omitted in an alternate embodiment. Preferably still, fold 31 or fold 33 may be formed at an acute angle to further secure the information materials between panels 11 and 12 by biasing device towards the motor vehicle widow when the window is closed, although similar results may be achieved even if fold 33 is nominal or omitted in an alternate embodiment.

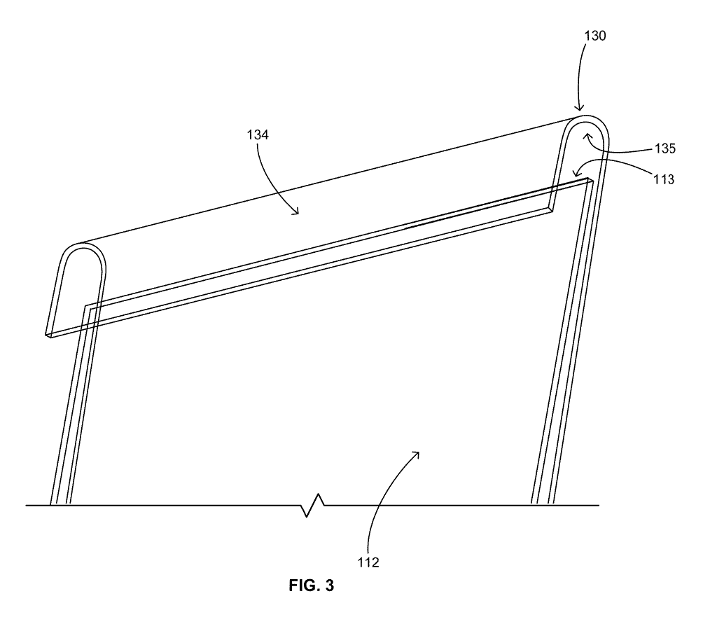

An alternate embodiment device 110 is shown in FIG. 3. Device 110 is similar to device 10, with like elements being labeled with like reference numerals within the 100-series of numbers. For instance, device 10 includes a clip 130. However, unlike the rectangular profile of clip 30, clip 130 exhibits a curvilinear profile comprised of an interior arc 135. Nonetheless, in a similar fashion to clip 30, clip 130 is designed to accept a portion of the top edge of an open motor vehicle window and to fit into a motor vehicle window well when the motor vehicle window is closed. In this embodiment, interior arc 135 may have a measure that exceeds 90 degrees and a diameter equivalent to at least the sum of the width of a motor vehicle window plus the width of panel 112 so as to bias panel 112 towards the motor vehicle widow when the window is closed. Alternatively still, as also shown particularly in FIG. 3, clip 130 may have a face portion 134 that extends downward from the open end of interior arc 135 to secure the face of panel 12 firmly against the motor vehicle window when the window is open.

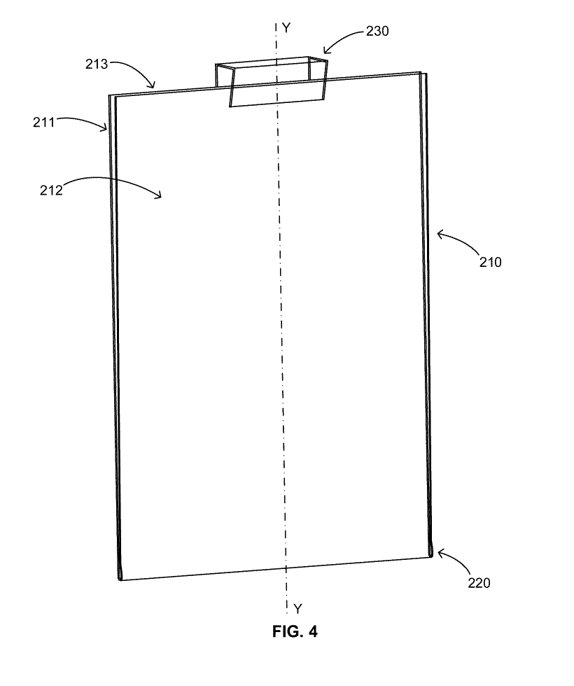

In FIGS. 1-3, clip 30 and clip 130 are shown extending lengthwise along the entire length of upper edges 13, 113, respectively. In the alternate embodiment shown in FIG. 4, a device 210 includes a clip 230 that extends lengthwise along only a portion of the length of an upper edge 213. Although shown as being of a particular length in FIG. 4, it is to be understood that clip 230 may be of any length along edge 213.

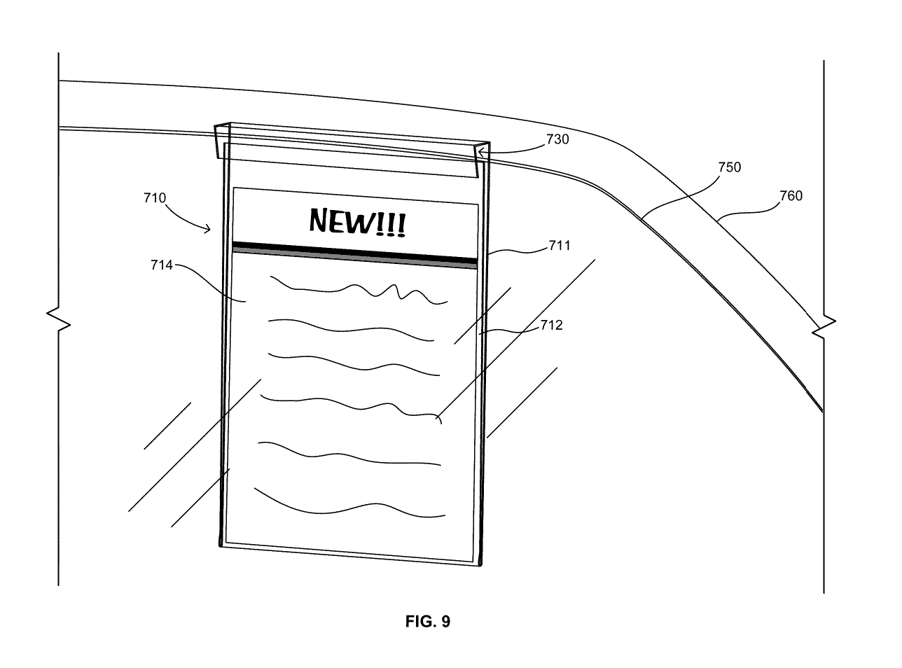

Similar to the construction of fold 20 noted above, any of the foregoing clips may be formed from a single sheet of polymeric material. Contrary to fold 20, however, the clips preferably exhibit a larger width or radius that, in turn, produces a correspondingly larger space between the clip and the other components of display device. This space, as discussed herein, is what allows clip 30 to accept a portion of the top edge of an open motor vehicle window. Likewise, the outer dimensions of the clips are preferably such that the device can fit into a motor vehicle window well when the motor vehicle window is closed, as best shown in FIGS. 9 through 11, which are discussed further below.

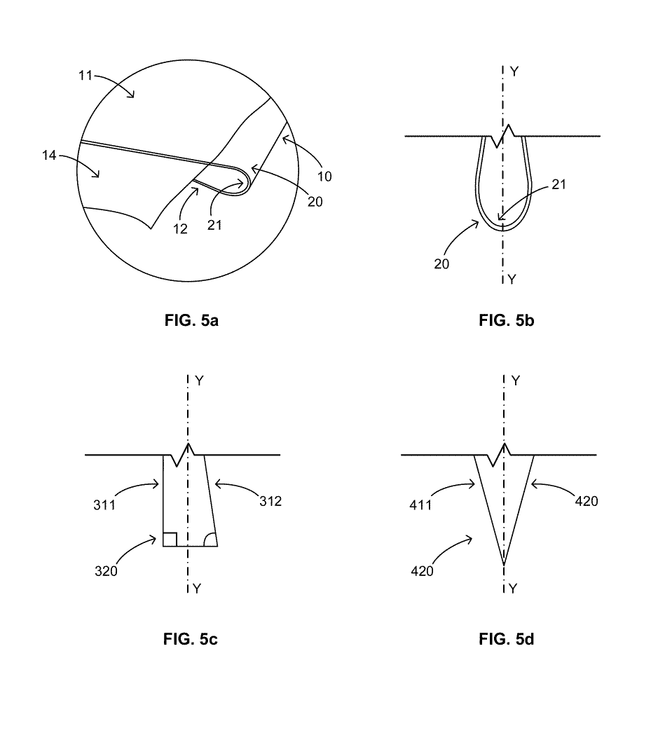

FIGS. 1 and 2 depict device 10 as including a fold 20 having a curvilinear profile, which is better shown in the enlarged views of FIGS. 5a and 5b. As shown, fold 20 has a curvilinear profile comprised of an interior arc 21. Arc 21 preferably has a measure that exceeds 180 degrees and a diameter of at least two centimeters so as to impart a clamping force between panels 11 and 12 for securing the information materials 14 in a fixed position between the panels.

Alternatively, as best shown in FIG. 5c, a fold 320, similar to fold 20, may have a rectangular profile. Like fold 20, fold 320 may be also designed to impart a clamping force between panels 311 and 312 when either corner of the rectangular profile of fold 320 is formed at an acute angle. Alternatively still, as shown in FIG. 5d, a fold 420, also similar to fold 20, may have an angular profile comprising an acute angle between the lower edges of a panel 411 and a panel 412. Similar to above, fold 420 preferably permits sufficient space between the panels for containing and displaying the informational materials, while also imparting a clamping force between the panels.

In any embodiment, fold 20 is preferably constructed by folding a single sheet of clear polymeric material so as to allow panels 11 and 12 to move away from one another about fold 20, and to impart a clamping force between the panels, regardless of whether its profile is angular, rectangular or curvilinear. However other methods of constructing fold 20 are also contemplated, such as, for example, heat sealing the lower edges of separate panels 11 and 12, or other means appropriate to the selected material type and embodiment.

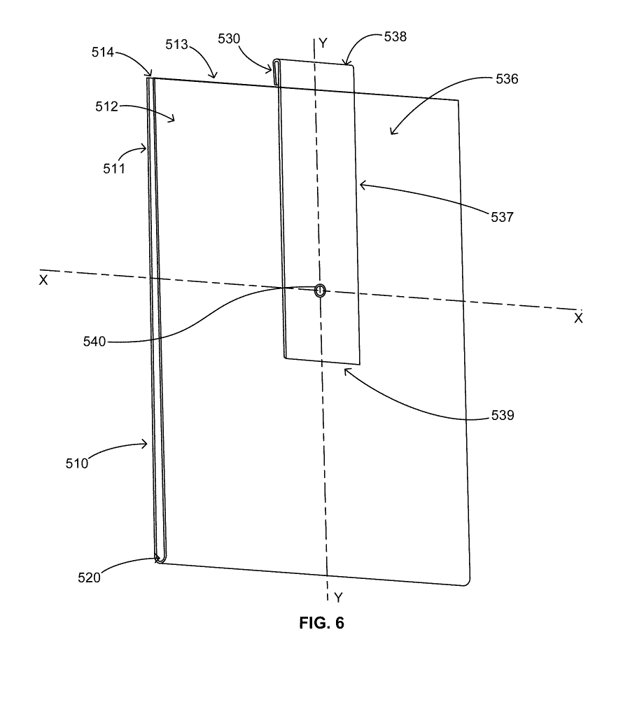

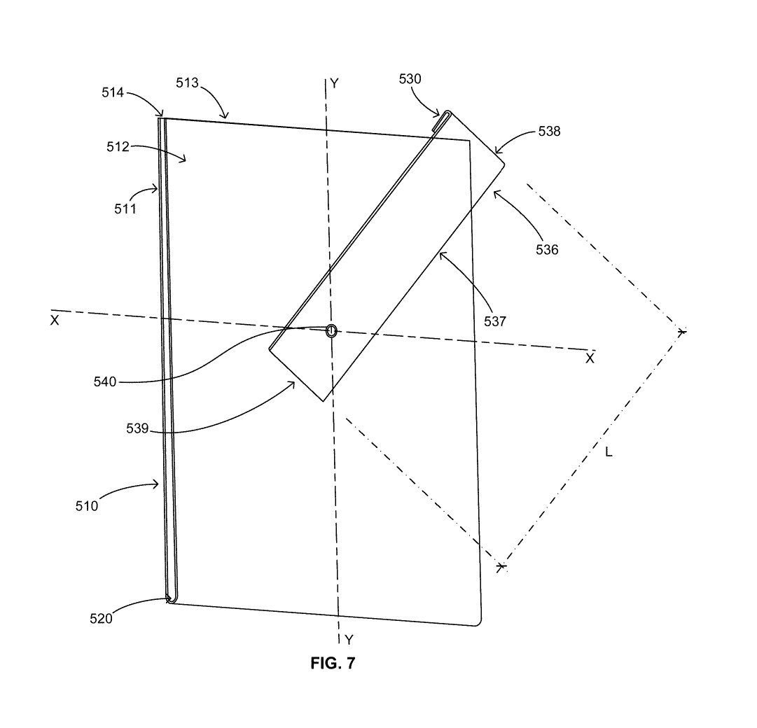

In yet another embodiment of the invention, as shown in FIGS. 6 and 7, an upper edge 513 of a panel 512 and an upper edge 514 of a panel 511 may extend upward an equal distance opposite of a fold 520. In this embodiment, the holding portion formed between panel 511 and panel 512 is attached to the motor vehicle window by a clip portion 536, which may comprise a clip 530 (having any of the profiles described above), an elongated body portion 537, and a rotatable connection 540. Clip 530 is connected lengthwise along at least one length of an upper edge 538 of the elongated body portion 537 and sized so as to accept a portion of the top edge of an open motor vehicle window and to fit into a motor vehicle window well when the motor vehicle window is closed.

Here, rotatable connection 540 is preferably located at the intersection of longitudinal axis Y-Y and a transverse axis X-X of panel 512, a point also known as the centroid of panel 512. But of course, connection 540 may be located at any point of display device 510.

As shown particularly in FIG. 7, clip portion 536 may be rotatably connected by rotatable connection 540 to panel 512 proximate to a lower edge 539 of elongated body portion 537, and sized so as to permit the interior face of clip 530 to rotate about rotatable connection 540 past each corner of the panels 511 and 512. Such a design may allow for device 510 to not only allow for display in portrait, but also in landscape. To achieve this result, as best shown in FIG. 7, elongated body portion 537 preferably has a minimum length L that extends outward from rotatable connection 540 towards upper edge 538 a distance greater than the hypotenuse of the right triangle formed by bisecting the largest quadrant of either panel 511 or panel 512.

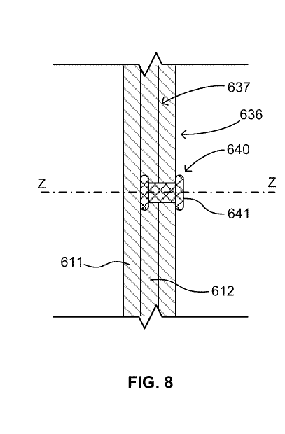

As also shown in FIG. 8, rotatable connection 640 may be comprised of a rivet 641, or similar fastening mechanism, that extends through panel 612 and elongated body portion 637 to rotatably connect clip portion 636 to panel 612. In this embodiment, rotatable connection 640 preferably secures clip portion 636 to panel 612 with sufficient force about a longitudinal axis Z-Z to impart friction between the interior face of elongated portion 637 and the exterior face of panel 612. Such friction being capable of holding either axis X-X or axis Y-Y of panel 612, and thus the reading axis for the information materials contained between panels 611 and 612, in a fixed position at any angle relative to the longitudinal axis of clip portion 636 without an additional fixation means.

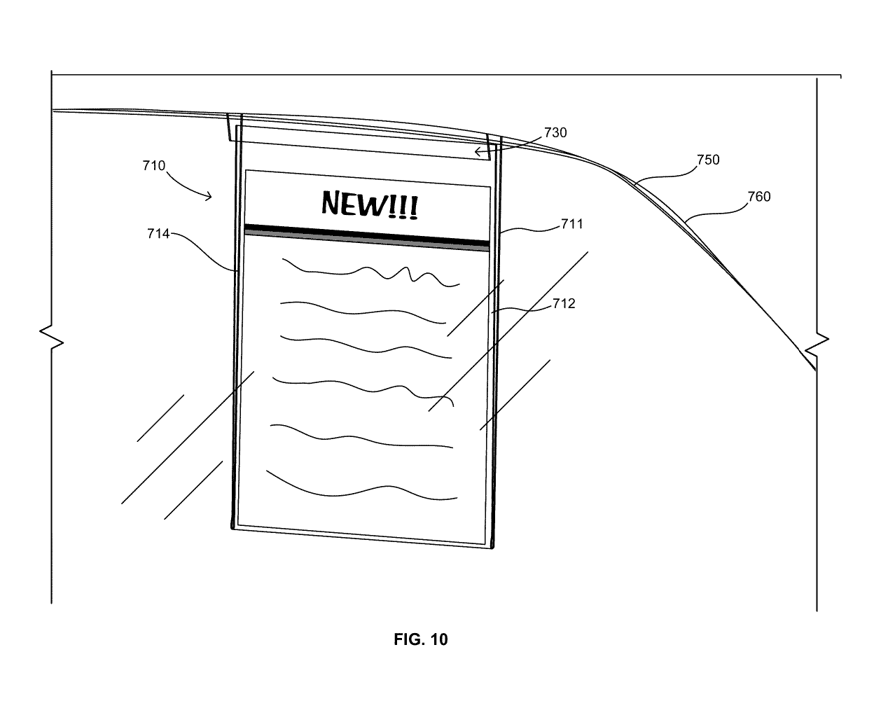

FIGS. 9 and 10 depict one particular use for display device 10. In FIG. 9, clip 30 is shown placed over open motor vehicle window 750, while FIG. 10 depicts device 10 placed on a fully closed window 750 so that clip 30 is at least partially disposed within window well 751. In both figures, information materials 714 are inserted between the panels 11 and 12, whereupon a combination of the material of display device 10 and the interactions of its components with window 750 impart a clamping force for securing the information materials in a fixed position.

Although FIGS. 9 and 10 depict one particular car window 750, it is noted that different window designs may dictate the need for different embodiment display devices, which may incorporate any of the variations discussed above. For example, the panels of the display device may be formed to match the curvature of the interior face of a given window, or the clip may be formed to match to curvature of the top edge of a given window. As another example, the length of a particular clip may be reduced (like in clip 230 of FIG. 4) where the corresponding window has less of a straight top edge. As yet another example, more curvilinear or angular window designs may require the embodiments of FIGS. 6 and 7, where the rotatability of clip portion 536 about rotatable connection 540 preferably allows for the display of the information materials in a portrait or landscape fashion.

As shown in FIG. 10, clip 730, or its numerical equivalent, is not only preferably sized and shaped to accept a portion of the motor vehicle window, but also to be accepted within the upper portion of the window well 751 upon closure of motor vehicle window 750. This of course may require differently sized devices to be provided in order to properly interact with differently sized motor vehicles and motor vehicle windows. But in all cases, the result of device 10 is the prominent display of information materials, much like information stickers often found on new motor vehicles, without the use of adhesive or similar fixable connection.

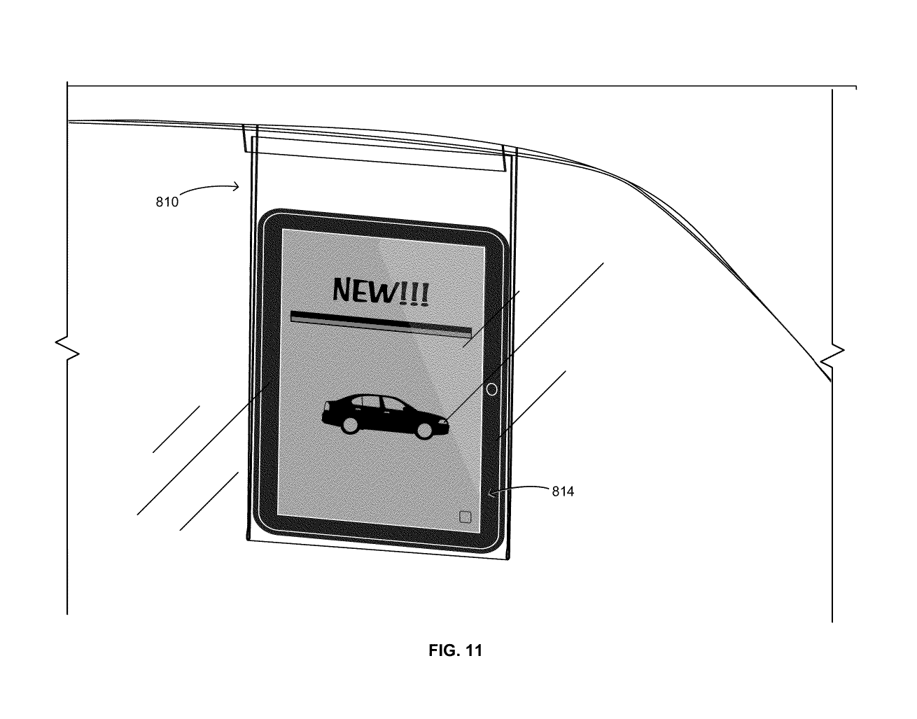

Finally, FIG. 11 depicts another embodiment display device 810 configured to display informational materials 814 in the form of digital screen technologies For instance, the informational materials may be displayed in an electronic device such as a tablet computer or the like. In this embodiment, display device 810 is preferably constructed to properly and safely hold display screen 814 in a fixed position. In certain instances, this may simply be the result of varying the dimensional relationships among the various components of the display device. However, in other embodiments, the device structure may be modified to better capture the electronic device.

Although various embodiments are depicted in the figures and described above, design variations are possible and contemplated. For instance, although discussed in connection with a motor vehicle and its windows, it is noted that other embodiment display devices in accordance with the present invention can be constructed so as to cooperate with other external components, such as windows of dwellings and the like. Moreover, although discussed in the context of motor vehicle sales, the present invention may be useful in other contexts as well. For instance, a device in accordance with the present invention may be useful in holding material sheets designed to provide daily assignments to truck drivers and the like. It is also contemplated to utilize more than one device on a given vehicle. In this instance, one device may contain a material sheet conveying the specs of the vehicle, while another device may contain a material sheet conveying the current offers and/or promotions being provided. Of course, any number of devices may be employed in a given instance.

Although the invention herein has been described with reference to particular embodiments and manufacturing methods, it is to be understood that these embodiments and methods are merely illustrative of the principles and applications of the present invention. It is therefore to be understood that numerous modifications may be made to the illustrative embodiments and methods, and that other arrangements may be devised without departing from the spirit and scope of the present invention as defined by the appended claims.

1. A display device for containing and displaying informational material comprising:
a housing portion having a first panel and a second panel, with at least a of portion of the first panel being substantially transparent, and each panel having an upper edge and a lower edge, wherein the panels are connected about the lower edges to create a folder capable of holding informational material; and
a clip connected to the second panel, wherein the clip is sized so as to accept a portion of the top edge of a motor vehicle window and to fit into an upper portion of a motor vehicle window well when the motor vehicle window is closed.

2. A display device as in claim 1, wherein the housing portion is substantially planar.

3. A display device as in claim 1, wherein the clip has a rectangular profile.

4. A display device as in claim 1, wherein the clip has a curvilinear profile having an interior arc with an open end.

5. A display device as in claim 4, wherein the clip has a face portion that extends downward from the open end of the interior arc.

6. A display device as in one of claim 1, in which the clip is connected lengthwise along a portion of the upper edge of the second panel.

7. A display device as in claim 1, wherein the first and second panels are connected about the lower edges by a fold with a curvilinear profile having an interior arc.
